(19) United States
(12) Patent Application Publication
(10) Pub. No.: US 2009/0130008 A1
(43) Pub. Date: May 21, 2009

(54) Process for Removing Hydrogen Disulfide from Gas

(76) Inventor: Michael N. Funk, Colbert, WA (US)

Correspondence Address: FROST BROWN TODD, LLC, 2200 PNC CENTER, 201 E. FIFTH STREET, CINCINNATI, OH, 45202, US

(21) Appl. No.: 12/250,874

(22) Filed: Oct. 14, 2008

Related U.S. Application Data
(60) Provisional application No. 61/003,621, filed on Nov. 19, 2007.

(51) Int. Cl. B01D 53/52; B01D 53/22

(52) U.S. Cl. 423/224; 422/169

(57) ABSTRACT

A reactor and process for removing hydrogen sulfide from gas. The reactor vessel contains an oxidizing solution and packing, where the packing fill about 25% to about 75% of the liquid volume of the vessel.

### CROSS REFERENCE TO RELATED APPLICATIONS

The present application hereby claims the benefit of the provisional patent application of the same title, Ser. No. 61/003,621, filed on Nov. 19, 2007, the disclosure of which is hereby incorporated by reference in its entirety.

### BACKGROUND

Biogas is a potential renewable energy source that may be produced from anaerobic digestion. It may occur naturally in landfills or in controlled environments that enhance the biological degradation of sewage waste, foodstuff waste, or animal waste.

Biogas and other sour gases are often not useful as an energy source because they are a low btu gas often containing hydrogen sulfide (H₂S), carbon dioxide, and water. Hydrogen sulfide has a foul odor, is toxic, and corrosive. Biogas containing hydrogen sulfide is very corrosive to equipment that burns it for fuel. Combustion of hydrogen sulfide oxidizes it to sulfur dioxide which contributes to acid rain.

Hydrogen sulfide may be removed from a gas through a number of different methods such as chemical or biological oxidation. However the expense of removing the hydrogen sulfide may make the use of the gas uneconomical. Consequently, a significant need exists for an efficient method for removal of hydrogen sulfide from a gas.

### BRIEF SUMMARY

The above-noted and other deficiencies may be overcome by providing a reactor for removing hydrogen sulfide from gas comprising: a vessel containing packing and a solution comprising an oxidant and water; and a diffuser for the gas; where the random packing fills about 25% to about 75% liquid volume of the vessel.

Hydrogen sulfide may be removed from a gas by a process comprising the steps of: diffusing the gas; and passing the diffused gas through a vessel containing packing and a solution comprising an oxidant and water; where the packing fills about 25% to about 75% of the liquid volume of the vessel.

These and other objects and advantages shall be made apparent from the accompanying drawings and the description thereof

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is a process flow diagram of an embodiment of the overall process for removing hydrogen sulfide from gas.

### DETAILED DESCRIPTION

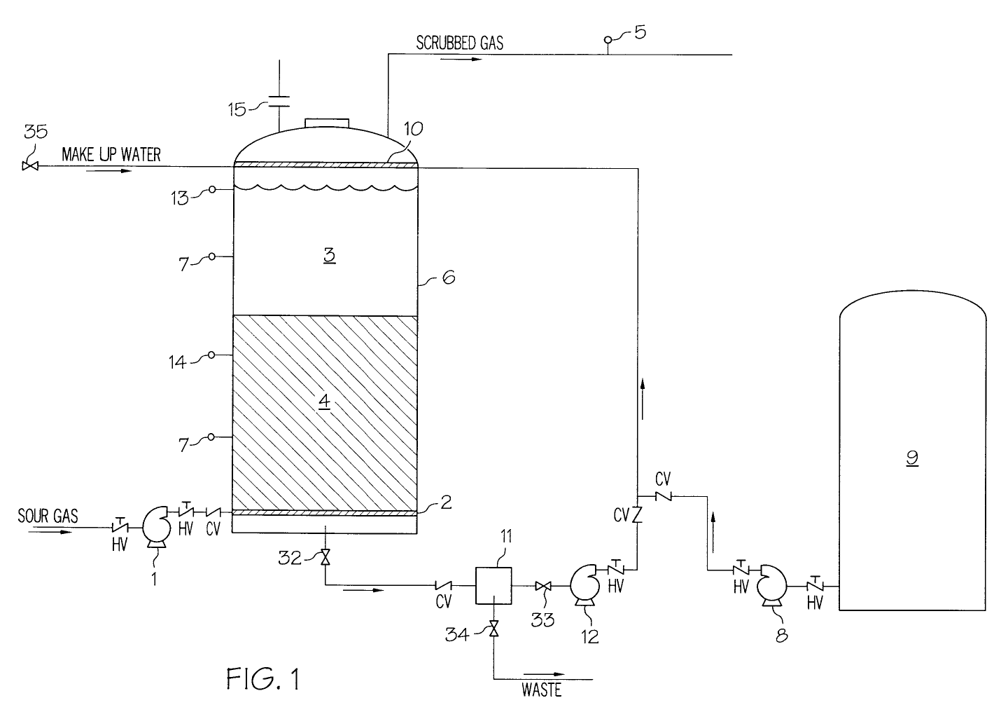

An embodiment depicted in FIG. 1 will be described below in further detail by reviewing each of the individual parts. Hand valves are labeled HV, and check valves are labeled CV.

The blower (1), which may be driven by a variable frequency drive (VFD) motor, may be used to elevate the pressure of the gas (sour gas or biogas) from the source to allow proper flow through the gas diffuser (2). The blower's VFD motor's throughput may be controlled by a pressure sensor at the gas source, the hydrogen sulfide monitor (5), and the demand for clean gas. If the pressure becomes too high, it may be released through the pressure release valve (15).

The gas diffuser (2) is used to evenly diffuse the gas through the oxidizing solution (3) and the packing (4). The gas diffuser creates smaller bubbles. Smaller bubbles have a higher surface to volume ratio which allows more interaction between the hydrogen sulfide and the oxidant. In general smaller bubbles oxidize the hydrogen sulfide more rapidly. The bubble size is determined in part by the pore size of the gas diffuser. The mean pore size of the gas diffuser may be from about 0.2 to about 100 microns. The mean pore size may be from about 1 to about 75 microns, from about 5 to about 50 microns, from about 10 to about 40 microns, about 20, about 25, about 30, about 35, or about 37 microns. There may be a single gas diffuser or there may be multiple gas diffusers.

The packing (4) is used to maximize surface contact between the gas and the oxidizing solution. The packing may be any type of material that could be used to decrease bubble coalescence, including random packing, structured packing, conventional trays, and high performance trays. Structural packing material could be a manufactured to fit inside the vessel. Random packing may be made from plastic or metal, it may be any shape. Examples of random packing are INTALOX SNOWFLAKE, FLEXIRING, and IMTP. The packing may have a void fraction from about 93% to about 98%, or about 95% to about 97%. The packing may be all of one type of material, or it may be a mixture. It may be a mixture of random packing and structural packing.

The packing (4) fills about 25% to about 75% of the liquid volume of the oxidizing vessel (6). The packing may fill from about 35% to about 65%, from about 40% to about 60%, about 40%, about 50%, or about 60% of the liquid volume of the oxidizing vessel (6). The vessel may be filled to the top with oxidizing solution, in which case, packing that fills about 50% of the liquid volume also fills about 50% of the vessel volume. Typically the vessel will be more than 50% full of oxidizing solution, more than 70% full, more than 80% full, or more than 90% full.

Oxidation reduction/pH Probes (7) measure the oxidation potential and the pH of the oxidizing solution (3). The ORP/pH Probes (7) along with the hydrogen sulfide monitor (5) may control the chemical injection pump (8). If the oxidation potential of the oxidizing solution (3) falls below the required level to remove the hydrogen sulfide or the hydrogen sulfide monitor (5) detects hydrogen sulfide in the departing scrubbed gas, then the chemical injection pump (8) injects oxidant from the bulk storage tank (9) through the oxidizing solution distributor (10) until the system removes more hydrogen sulfide.

The pH of the oxidizing solution may be adjusted by adding acid or base to the solution. It may fluctuate during the removal of hydrogen sulfide. Typically the pH is from about 3 to about 8, it may be from about 5 to 7.5.

The temperature of the oxidizing solution is measured by the temperature probe (14). The temperature may be adjusted by heating or cooling it. Typically the rate of oxidation of hydrogen sulfide will be faster at a higher temperature. However, the temperature should not be too high as it may increase the rate at which the oxidant decomposes. The temperature of the solution may be from about 55° F. to about 200° F., from about 65° F. to about 150° F., or from about 75° F. to about 120° F.

The oxidizing solution is a solution that contains one or more dissolved or suspended oxidants. Examples of an oxidant are hydrogen peroxide, other peroxides, ozone, permanganates, hypochlorite, perchlorate, ammonium cerium nitrate, hexavalent chromium compounds, iodine, and sulfoxides. The solution may be water, an organic solvent such as toluene; an alcohol, such as methanol, ethanol, isopropanol; acetone; dioxane; tetrahydrofuran; acetonitrile; dimethylformamide; dimethyl sulfoxide; esters, such as ethyl acetate; chlorinated solvents, such as chloroform, methylene chloride, carbon tetrachloride; hydrocarbons, such as pentane, hexane, heptane, and heavier hydrocarbons; or combinations of solvents.

The concentration of oxidant in the oxidizing solution may be not more than about 1%, not more than about 0.5%, or not more than about 0.25% when the concentration of hydrogen sulfide is about 0.25%. The ratio of the oxidizing solution percent concentration to the hydrogen sulfide percent concentration may be about 4:1, about 2:1, or about 1:1.

As the chemical injection pump (8) introduces additional oxidizing solution into the system the level indicator (13) on the oxidizing solution tank may cause the flow valve (32) to open. The spent oxidizing solution which contains elemental sulfur may then go through the sulfur recovery system (11). After removing the sulfur, the spent oxidizing solution can be recirculated through circulation pump (12) and mixed with oxidant to be used as oxidizing solution (3) which is delivered through the oxidizing solution distributor (10), or discharged as waste water. Flow valve (33) and flow valve (34) control the direction of the waste water, which is dependent upon the system's demand for additional mixing solution. The flow valve (35) is used to introduce additional water (make up water) when the level indicator (13) indicates a need for additional solution and the ORP/pH probes (7) do not indicate a need for additional oxidant.

During optimal system performance where the oxidizing solution (3) is removing all or substantially all of the hydrogen sulfide, the gas may be delivered to the point of demand. The hydrogen sulfide concentration in the scrubbed gas may be less than 400 ppm, 300 ppm, 200 ppm, 100 ppm, or less than 1 ppm.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art.

### EXAMPLES

Several experiments were performed using an oxidizing vessel with a capacity of 105 gallons (14 cubic feet). Gas containing 65% methane, 39.75% carbon dioxide, and 2500 ppm hydrogen sulfide was bubbled into the oxidizing vessel through a ceramic dome gas diffuser that produced fine bubbles. The gas flow rate was 2 cubic feet per minute. The oxidizing solution was 0.5% hydrogen peroxide.

### Example 1

In this experiment about 6 cubic feet of plastic packing was used in the vessel (approximately 50% of the liquid volume of the vessel) with enough oxidizing solution to fill the vessel to about 12 cubic feet. The temperature of the oxidizing solution was 78° F. The initial ORP was 220 mV and the pH was 8.1. After 12 minutes, the ORP was 326, the pH was 5.3, and the hydrogen sulfide concentration of the scrubbed gas was 138 ppm. After 25 minutes, the ORP was 338 mV, the pH was 5.2, and the hydrogen sulfide concentration was 96 ppm.

### Example 2

In this experiment about 12 cubic feet of plastic packing was used in the vessel (approximately 100% of the liquid volume of the vessel) with enough oxidizing solution to fill the vessel to about 12 cubic feet. The temperature of the oxidizing solution was 78° F. After 25 minutes, the hydrogen sulfide concentration was 400 ppm.

### Example 3

In this experiment about 12 cubic feet of plastic packing was used in the vessel (approximately 100% of the liquid volume of the vessel) with enough oxidizing solution to fill the vessel to about 12 cubic feet. The temperature of the oxidizing solution was 115° F. After 12 minutes, the ORP was 310 mV, the pH was 5.4, the hydrogen sulfide concentration was 239 ppm.

What is claimed is:

1. A process for removing hydrogen sulfide from gas comprising the steps of:
diffusing the gas; and
passing the diffused gas through a vessel containing packing and a solution comprising an oxidant and water, where the packing fills about 25% to about 75% of the liquid volume of the vessel.

2. The process of claim 1, where the temperature of the solution is from about 55° F. to about 200° F.

3. The process of claim 1, where the pH of the solution is from about 3 to about 8.

4. The process of claim 1, where the packing has a void fraction from about 93% to about 98%.

5. The process of claim 1, where the oxidant is hydrogen peroxide.

6. The process of claim 1, where the diffused gas is formed by passing the gas through a diffuser with a pore size of from about 0.2 to about 100 microns.

7. The process of claim 1, where the ORP of the solution is above about 300 mV.

8. The process of claim 1, where the packing fills about half of the liquid volume of the vessel.

9. The process of claim 1, where the packing is random packing.

10. A reactor for removing hydrogen sulfide from gas comprising:
a vessel containing packing and a solution comprising an oxidant and water; and
a diffuser for the gas;
where the packing fills about 25% to about 75% of the vessel.

11. The reactor of claim 10, where the packing has a void fraction from about 93% to about 98%.

12. The reactor of claim 10, where the diffuser has a porosity of from about 0.2 to about 100 microns.

13. The reactor of claim 10, where the packing fills about half of the vessel.

14. The reactor of claim 10, where the packing is random packing.
